(19) United States
(12) Patent Application Publication
(10) Pub. No.: US 2013/0166944 A1
(43) Pub. Date: Jun. 27, 2013

(54) SEMICONDUCTOR MEMORY DEVICE AND OPERATION METHOD THEREOF

(71) Applicant: Heat-Bit PARK, Gyeonggi-do (KR)

(72) Inventor: Heat-Bit PARK, Gyeonggi-do (KR)

(21) Appl. No.: 13/460,953

(22) Filed: May 1, 2012

(30) Foreign Application Priority Data
Dec. 21, 2011 (KR) 10-2011-0139643

(51) Int. Cl. G06F 11/20

(52) U.S. Cl. 714/6.3; 714/E11.089

(57) ABSTRACT

A semiconductor memory device includes a memory cell array comprising a normal memory cell and a redundancy memory cell and configured to store data, a data compression unit configured to compress data stored in the memory cell array and generate compression information, and a repair control unit configured to control a repair operation for accessing the redundancy memory cell in response to the compression information.

### CROSS-REFERENCE TO RELATED APPLICATIONS

The present application claims priority of Korean Patent Application No. 10-2011-0139643, filed on Dec. 21, 2011, which is incorporated herein by reference in its entirety.

### BACKGROUND

1. Field

Exemplary embodiments of the present invention relate to semiconductor design technology, and more particularly, to a semiconductor memory device including normal memory cells and redundancy memory cells.

2. Description of the Related Art

Semiconductor memory devices such as DDR SDRAM (Double Data Rate Synchronous DRAM) may include a large number of memory cells. With the development of semiconductor manufacturing process technology, the integration degree of semiconductor memory devices has increased, and the number of memory cells has further increased. When a memory cell fails a test, a semiconductor memory device including the memory cell that failed a test does not perform a desired operation, and thus the semiconductor memory device should be discarded. However, as the manufacturing process technology of semiconductor memory devices develops, only in a small number of memory cells may fail a test. When a semiconductor memory device having such a small number of memory cells that failed a test is discarded, the yield is inefficient.

Therefore, to compensate for the memory cells that fail a test, the semiconductor memory device includes redundancy memory cells in addition to normal memory cells.

A redundancy memory cell is a circuit that is provided to repair a normal memory cell that fails a test (hereafter, referred to as ‘repair target memory cell’). More specifically, when a repair target memory cell is accessed during a read/write operation, a redundancy memory cell is internally accessed instead of a repair target memory cell. Therefore, the semiconductor memory device performs an operation to access the redundancy memory cell instead of the repair target memory cell (hereafter, referred to as ‘repair operation’) when an address corresponding to the repair target memory cell is inputted to the semiconductor memory device. The semiconductor memory device may perform an operation through such a repair operation.

Additionally, the semiconductor memory device requires additional circuits as well as redundancy memory cells to perform a repair operation. The circuits may include a repair fuse circuit. The repair fuse circuit stores an address corresponding to the repair target memory cell (hereafter, referred to as ‘repair target address), and a repair target address is programmed in fuses provided in the repair fuse circuit. The semiconductor device performs a repair operation using the repair target address programmed in such a manner. Here, the programming refers to a series of operations for storing data in the fuses.

FIG. 1 is a block diagram illustrating the configuration of a conventional semiconductor memory device.

Referring to FIG. 1, the semiconductor memory device includes a memory cell array 110, a column select control unit 120, and a repair fuse unit 130.

The memory cell array 110 includes a plurality of memory cells for storing data, and the plurality of memory cells include normal memory cells and redundancy memory cells. The column select control unit 120 is configured to generate a column select signal YI in response to an address ADD inputted from a circuit outside of the semiconductor memory device. Here, the column select signal VI is a signal for selecting a memory cell corresponding to the address ADD among the plurality of memory cells provided in the memory cell array 110. The repair fuse unit 130 includes a plurality of fuses. The repair target address is programmed into the plurality of fuses. The repair fuse unit 130 is configured to compare the address ADD with the repair target address and transmit the comparison result to the column select control unit 120. The column select control unit 120 generates the column select signal YI for selecting a normal memory cell or redundancy memory cell according to the transmitted comparison result.

Additionally, data is stored in the plurality of fuses provided in the repair fuse unit 130 through a programming operation. In general, representative programming methods include a laser cutting method and an electrical cutting method. In the laser cutting method, laser beams are used to blow a fuse according to data that is to be stored, and in the electrical cutting method, a fuse is molten by applying an over current to the fuse according to data that is to be stored. According to an example, the laser cutting method may be performed more simply than the electrical cutting method, but the laser cutting method should be performed when the semiconductor device in a wafer state before the semiconductor device is fabricated as a package.

As described above, both of the laser cutting method and the electrical cutting method for storing a repair target address in the fuses provided in the repair fuse unit 130 needs to be performed after the repair target address is recognized. More specifically, the repair target address is to be recognized to perform a programming operation on the repair fuse unit 130. The repair target address is to be recognized because the programming operation performed on the repair fuse unit 130 is passively performed.

### SUMMARY

An embodiment of the present invention is directed to a semiconductor memory device capable of actively performing a programming operation of a repair fuse corresponding to a repair target memory cell.

In accordance with an embodiment of the present invention, a semiconductor memory device includes: a memory cell array comprising a normal memory cell and a redundancy memory cell and configured to store data; a data compression unit configured to compress data stored in the memory cell array and generate compression information; and a repair control unit configured to control a repair operation for accessing the redundancy memory cell in response to the compression information.

In accordance with another embodiment of the present invention, a semiconductor memory device includes: a memory cell array comprising a normal memory cell and a redundancy memory cell and configured to store data; a data compression unit configured to compress data stored in the memory cell array and generate compression information; an information storage unit configured to store the compression information and generate an output signal; and a signal selection unit configured to activate a normal select signal for accessing the normal memory cell or a redundancy select signal for accessing the redundancy memory cell in response to the output signal of the information storage unit.

In accordance with yet another embodiment of the present invention, a semiconductor memory device includes: a memory cell array comprising a normal memory cell and a redundancy memory cell and configured to store data; a data compression unit configured to compress data stored in memory cell groups each obtained by grouping a first number of memory cells in the memory cell array and generate compression information; a plurality of information storage units configured to store the compression information corresponding to the respective memory cell groups and generate an output signals; a signal select unit configured to activate a normal select signal for accessing the normal memory cell or a redundancy select signal for accessing the redundancy memory cell in response to the output signals of the information storage units; and an address reflection unit configured to output an address as the normal select signal and the redundancy select signal and activate a final select signal.

In accordance with still another embodiment of the present invention, a semiconductor memory device includes: a plurality of memory cell arrays each comprising a normal memory cell and a redundancy memory cell and configured to store data; a data compression unit configured to compress data stored in a plurality of memory cell arrays corresponding to an address among the memory cell arrays and generate compression information; an address storage unit configured to store the address in response to the compression information and generate an output signal; an address comparison unit configured to compare the output signal of the address storage unit with an address applied during a memory operation; and a signal select control unit configured to activate a normal select signal for accessing the normal memory cell or a redundancy select signal for accessing the redundancy memory cell in response to an output signal of the address comparison unit.

In accordance with still another embodiment of the present invention, an operation method of a semiconductor memory device, includes: compressing data stored in a memory cell array; performing a programming operation on a fuse in response to an output signal of a compression unit that compresses the data stored in the memory cell array; and performing a repair operation for accessing a redundancy memory cell in response to an output signal corresponding to the fuse.

### BRIEF DESCRIPTION OF THE DRAWINGS

FIG. 1 is a block diagram illustrating the configuration of a conventional semiconductor memory device.

FIG. 2 is a block diagram illustrating the configuration of a semiconductor memory device in accordance with an embodiment of the present invention.

FIG. 3 is a circuit diagram illustrating a data compression unit of FIG. 2.

FIG. 4 is a block diagram illustrating a first embodiment of a repair control unit of FIG. 2.

FIG. 5 is a block diagram illustrating the configuration of a semiconductor memory device in accordance with another embodiment of the present invention.

FIG. 6 is a block diagram illustrating the configuration of a semiconductor memory device in accordance with yet another embodiment of the present invention.

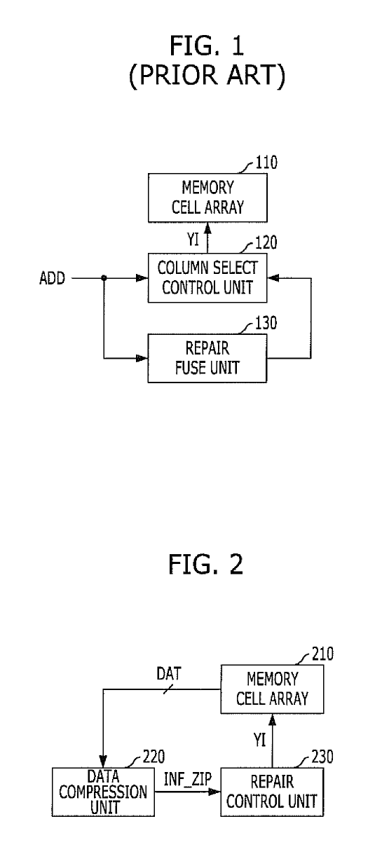

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

FIG. 2 is a block diagram illustrating the configuration of a semiconductor memory device in accordance with an embodiment of the present invention.

Referring to FIG. 2, the semiconductor memory device includes a memory cell array 210, a data compression unit 220, and a repair control unit 230.

The memory cell array 210 includes a plurality of memory cells for storing data, and the plurality of memory cells include normal memory cells and redundancy memory cells. The data compression unit 220 is configured to receive data DAT stored in the memory cell array 210 and compress the received data to generate compression information INF_ZIP during a compression test operation. The repair control unit 230 is configured to control a repair operation that accesses a redundancy memory cell of the memory cell array 210 in response to the compression information INF_ZIP.

Hereafter, a repair operation of the semiconductor memory device will be described with reference to FIG. 2.

First, the semiconductor memory device generates the compression information INF_ZIP through a compression test operation before a repair operation. More specifically, the semiconductor memory device stores data in the memory cell array 210 during the compression test operation, and the data compression unit 220 receives the stored data and compresses the received data to generate the compression information INF_ZIP. More specifically, during the compression test operation, the data may be stored in the memory cell array 210, and the compression information INF_ZIP contains information on whether or not data inputted to the memory cell array 210 corresponds to data that is stored in the memory cell array 210 and subsequently outputted. In other words, assuming that a memory cell in the memory cell array 210 failed a test, the inputted data does not correspond to the stored and outputted data, and the compression information INF_ZIP contains such information.

Subsequently, the semiconductor memory device performs a repair operation in response to the compression information INF_ZIP. More specifically, the repair control unit 230 generates a column select signal YI to access a normal memory cell or redundancy memory cell in the memory cell array 210 in response to the compression information INF_ZIP.

The semiconductor memory device in accordance with the embodiment of the present invention performs a compression test operation before a repair operation and performs a repair operation using the compression information INF_ZIP generated during the compression test operation. The semiconductor memory device performs the repair operation using the compression information INF_ZIP because the compression information INF_ZIP contains information corresponding to which memory cell fail occurred test, i.e., information corresponding to a repair target memory cell. As will be described below, the semiconductor memory device may perform a repair operation on a repair target memory cell through such an operation without additional repair equipment, even after the semiconductor memory device is fabricated.

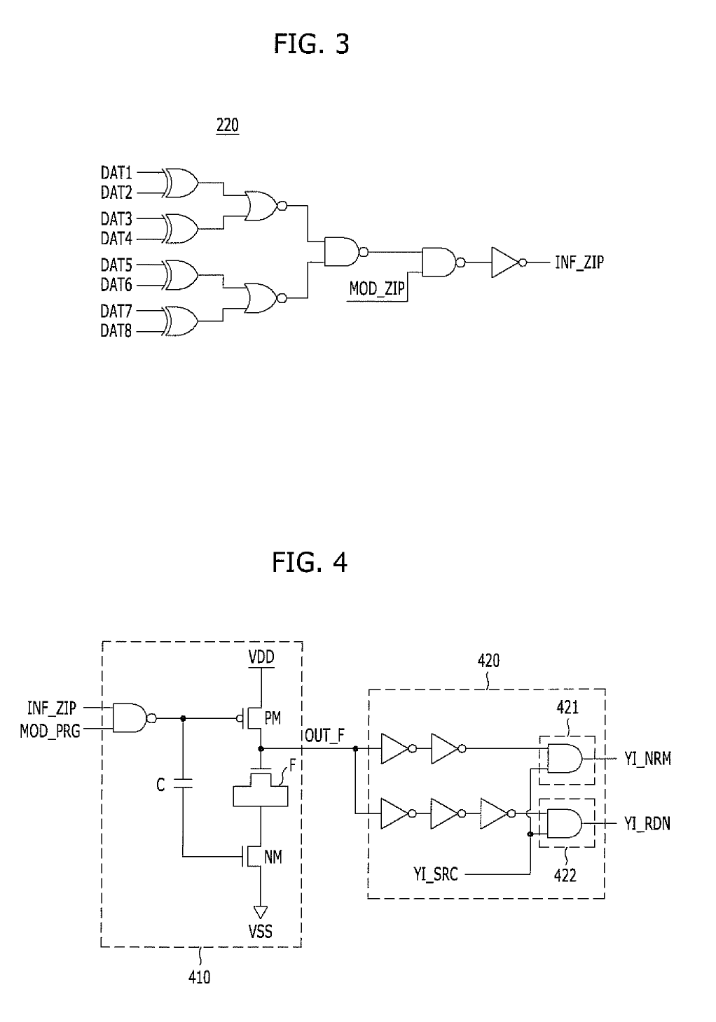

FIG. 3 is a circuit diagram illustrating the data compression unit 220 of FIG. 2.

Referring to FIGS. 2 and 3, the data compression unit 220 is configured to compress a plurality of data DAT1 to DAT8 outputted from the memory cell array 210 and output the compressed data as the compression information INF_ZIP during a compression test operation, and the data compression unit 220 includes a plurality of XOR gates XOR, a plurality of NOR gates NOR, and a plurality of NAND gates NAND. The data compression unit 220 receives a mode signal MOD_ZIP corresponding to the compression test operation and outputs the compression information INF_ZIP in response to the mode signal MOD_ZIP. Here, the compression information INF_ZIP becomes a logic low level when the plurality of data DAT1 to DAT8 all have the same logic level, and the compression information INF_ZIP becomes a logic high level when any one of the data DAT1 to DAT8 has a different logic level. The logic level of the compression information INF_ZIP may differ depending on the design.

FIG. 4 is a block diagram illustrating a first embodiment of the repair control unit 230 of FIG. 2.

Referring to FIG. 4, the repair control unit 230 includes an information storage unit 410 and a column selection unit 420.

The information storage unit 410 is configured to store the compression information INF_ZIP during a fuse programming operation, and the compression information INF_ZIP is programmed Into an e-fuse F in response to a mode signal MOD_PRG corresponding to the fuse programming operation. More specifically, the e-fuse F is programmed in response to the compression information INF_ZIP.

Hereafter, referring to FIGS. 3 and 4, a simple circuit operation of the information storage unit 410 will be described.

First, when the plurality of data DAT1 to DAT8 all have the same logic level, that is, the compression information INF_ZIP is at a logic low level, or when a fuse programming operation is not performed, that is, the mode signal MOD_PRG corresponding to the fuse programming operation is at a logic low level, an NMOS transistor NM is turned on, and a ground voltage VSS is applied to source and drain terminals of the e-fuse F.

Subsequently, when the plurality of data DAT1 to DAT8 do not all have the same logic level, that is, when the compression Information INF_ZIP becomes a logic high level during the fuse programming operation, that is, in a state where the mode signal MOD_PRG is at a logic high level, a PMOS transistor PM is turned on. If the PMOS transistor PM is turned on, the voltage level of the gate terminal of the e-fuse F increases, and the e-fuse F is ruptured while a voltage level difference between the gate terminal and the drain/source terminal increases. Here, an output signal OUT_F of the information storage unit 410 becomes a logic low level when the e-fuse F is ruptured, and the output signal OUT_F becomes a logic high level when the e-fuse F is not ruptured. The programming operation of the e-fuse F may differ depending on the design.

For reference, a circuit for precharging the output signal OUT_F of the information storage unit 410 to a designated voltage level may be further provided. The circuit may be controlled by a signal corresponding to a power-up operation.

Additionally, the column selection unit 420 is configured to activate a normal column select signal YI_NRM or a redundancy column select signal YI_RDN in response to the compression information INF_ZIP stored in the e-fuse F of the information storage unit 410, and the column selection unit 420 includes a first select output section 421 and a second select output section 422.

The first select output section 421 is configured to output a source column select signal YI_SRC as the normal column select signal YI_NRM in response to the output signal OUT_F of the information storage unit 410, and the second select output section 422 is configured to output the source column select signal YI_SRC as the redundancy column select signal YI_RDN in response to the output signal OUT_F of the information storage unit 410. Here, the source column select signal YI_SRC is a pulse signal that is activated in response to a column command including a read/write operation of the semiconductor memory device.

The column selection unit 420 activates the normal column select signal YI_NRM when the output signal OUT_F of the information storage unit 410 is at a logic high level, and the column selection unit 420 activates the redundancy column select signal YI_RDN when the output signal OUT_F of the information storage unit 410 is at a logic low level. Here, when the output signal OUT_F of the information storage unit 410 is at a logic high level, the plurality of data DAT1 to DAT8 all have the same logic value. In this case, the normal column select signal YI_NRM is activated to access a normal memory cell. Furthermore, when the output signal OUT_F of the information storage unit 410 is at a logic low level, the plurality of data DAT1 to DAT8 do not all have the same logic value. In this case, the redundancy column select signal YI_RDN is activated to access a redundancy memory cell.

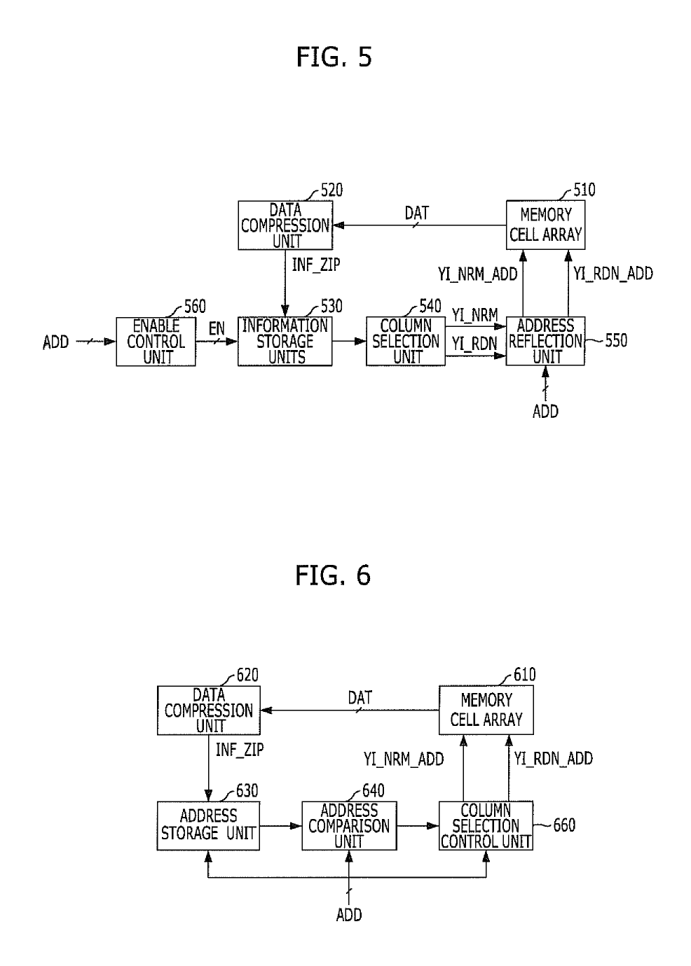

FIG. 5 is a block diagram illustrating the configuration of a semiconductor memory device in accordance with another embodiment of the present invention.

Referring to FIG. 5, the semiconductor memory device includes a memory cell array 510, a data compression unit 520, a plurality of information storage units 530, a column selection unit 540, an address reflection unit 550, and an enable control unit 560.

The memory cell array 510 includes a plurality of memory cells for storing data, and the plurality of memory cells include normal memory cells and redundancy memory cells. The data compression unit 520 is configured to receive a plurality of data DAT stored in a plurality of memory cell groups each obtained by grouping a number of memory cells in the memory cell array 510 and generate compression information INF_ZIP during a compression test operation. The plurality of information storage units 530 are configured to store compression information INF_ZIP corresponding to the number of memory cell groups, respectively. The column selection unit 540 is configured to activate a normal column select signal YI_NRM or a redundancy column select signal YI_RDN in response to the compression information INF_ZIP stored in the plurality of information storage units 530. The address reflection unit 550 is configured to output addresses ADD into the normal column select signal YI_NRM and the redundancy column select signal YI_RDN and activate a final column select signal YI_NRM_ADD for accessing a normal memory cell or a final column select signal YI_RDN_ADD for accessing a redundancy memory cell.

Additionally, the enable control unit 560 is configured to generate a plurality of enable signal EN in response to the plurality of addresses ADD. Here, the plurality of enable signals EN are signals for activating the plurality of information storage units 530, respectively, and the number of enable signals EN corresponds to the number of memory cell groups.

Hereafter, a repair operation of the semiconductor memory device in accordance with the embodiment of the present invention will be described.

First, the semiconductor memory device stores data in the memory cell array 510 through a compression test operation. Subsequently, the address reflection unit 550 generates a column select signal for enabling a number of memory cell groups in a normal memory cell array in response to the addresses ADD, and the data DAT stored in the memory cell groups are transmitted to the data compression unit 520 in response to the column select signal. The data compression unit 520 receives the stored data DAT and compresses the received data. The plurality of information storage units 530 store compression information INF_ZIP corresponding to the memory cell groups, respectively. The enable control unit 560 is configured to generate a plurality of enable signals EN corresponding to the addresses ADD, and the plurality of enable signals EN are used to store the compression information INF_ZIP of the memory cell groups in the corresponding information storage units 530.

Subsequently, the semiconductor memory device performs a repair operation using the compression information INF_ZIP stored in the plurality of storage information units 530. More specifically, during a read/write operation of the semiconductor memory device, the enable control unit 560 enables a corresponding information storage unit among the plurality of information storage units 530 in response to an inputted address ADD, and the column selection unit 540 generates a normal column select signal YI_NRM or a redundancy column select signal YI_RDN in response to the compression information INF_ZIP outputted from the corresponding information storage unit. Finally, the address reflection unit 550 reflects the normal column select signal YI_NRM and the redundancy column select signal YI_RDN into the address ADD, and activates the final column select signals YI_NRM_ADD and YI_RDN_ADD.

FIG. 6 is a block diagram illustrating the configuration of a semiconductor memory device in accordance with yet another embodiment of the present invention.

Referring to FIG. 6, the semiconductor memory device includes a memory cell array 610, a data compression unit 620, an address storage unit 630, an address comparison unit 640, and a column select control unit 660.

The memory cell array 610 includes a plurality of memory cells for storing data, and the plurality of memory cells include normal memory cells and redundancy memory cells. The data compression unit 520 is configured to receive data DAT stored in a plurality of normal memory cells corresponding to an address ADD in the memory cell array 610 and compress the received data to generate compression information INF_ZIP during a compression test operation.

The address storage unit 630 is configured to store the address ADD in response to the compression information INF_ZIP. Here, the address storage unit 630 is enabled in response to the compression information INF_ZIP and includes a plurality of fuse circuits programmed in response to a plurality of bits of the address ADD, respectively. At this time, the number of fuse circuits may correspond to the number of bits forming the address ADD. More specifically, the fuse circuits are enabled in response to the compression information INF_ZIP and programmed in the respective bits of the address ADD.

The address comparison unit 640 is configured to compare the address stored in the address storage unit 630 with an address ADD applied during a normal operation and transmit the comparison result to the column select control unit 660. The column select control unit 660 is configured to activate a normal column select signal YI_NRM_ADD for accessing a normal memory cell or a redundancy column select signal YI_RDN_ADD for accessing a redundancy memory cell in response to the comparison result.

Hereafter, a repair operation of the semiconductor memory device in accordance with the embodiment of the present invention will be described.

First, the semiconductor memory device stores data in the memory cell array 610 through a compression test operation. Subsequently, the column select control unit 660 generates a column select signal for enabling a number of memory cell groups in a normal memory cell array in response to an address ADD, and the column select control unit 660 transmits data DAT stored in the memory cell groups to the data compression unit 620 in response to the column select signal. The data compression unit 620 receives the stored data DAT and compresses the received data. Additionally, when a failed memory cell the memory cell array 610 is detected through the compression information INF_ZIP, the address storage unit 630 stores an address ADD corresponding to a memory cell that failed a test.

Subsequently, the semiconductor memory device performs a repair operation using the address ADD stored in the address storage unit 630. More specifically, during an operation of the semiconductor memory device, the address comparison unit 640 compares an inputted address ADD with the address stored in the address storage unit 630, and the column select control unit 660 activates the final column select signals YI_NRM_ADD and YI_RDN_ADD according to the comparison result. For reference, the column select control unit 660 may correspond to the column selection unit 540 and the address reflection unit 550 of FIG. 5.

In addition, the number of fuse circuits provided in the address storage unit 630 and grouped in one set may correspond to the bit number of the address ADD, and plural sets of fuse circuits may be provided. The number of sets may be set in consideration of a repair is operation after mass production.

As described above, the semiconductor memory device in accordance with the embodiments of the present invention performs a repair operation using the compression information INF_ZIP obtained by a compression operation. Therefore, although the address of a repair target memory cell is not recognized, the repair operation may be internally performed. This means that the semiconductor memory device may perform a repair operation even after the semiconductor memory device is fabricated.

The semiconductor memory device in accordance with the embodiments of the present invention may actively perform a programming operation of a repair fuse corresponding to a repair target memory cell. Therefore, the semiconductor memory device may perform a repair operation on a memory cell that failed a test without additional repair equipment even after the semiconductor memory device is fabricated.

Since the semiconductor memory device may perform a repair operation without additional repair equipment even after the semiconductor memory device is fabricated, the lifetime of the semiconductor memory device may be increased.

While the present invention has been described with respect to the specific embodiments, it will be apparent to those skilled in the art that various changes and modifications may be made without departing from the spirit and scope of the invention as defined in the following claims.

Additionally, the semiconductor memory device in accordance with the embodiments of the present invention performs a column repair operation as described above. However, the semiconductor memory device in accordance with the embodiments of the present invention may be applied to a row repair operation as well as the column repair operation.

Furthermore, the positions and types of the logic gates and the transistors in the above-described embodiments may be implemented in different manners according to the polarity of an inputted signal.

What is claimed is:

1. A semiconductor memory device comprising:
a memory cell array comprising a normal memory cell and a redundancy memory cell and configured to store data;
a data compression unit configured to compress data stored in the memory cell array and generate compression information; and
a repair control unit configured to control a repair operation for accessing the redundancy memory cell in response to the compression information.

2. The semiconductor memory device of claim 1, further comprising an information storage unit configured to store the compression information.

3. The semiconductor memory device of claim 2, wherein the information storage unit comprises a fuse circuit configured to be programmed in response to the compression information.

4. A semiconductor memory device comprising:
a memory cell array comprising a normal memory cell and a redundancy memory cell and configured to store data;
a data compression unit configured to compress data stored in the memory cell array and generate compression information;
an information storage unit configured to store the compression information and generate an output signal; and
a signal selection unit configured to activate a normal select signal for accessing the normal memory cell or a redundancy select signal for accessing the redundancy memory cell in response to the output signal of the information storage unit.

5. The semiconductor memory device of claim 4, wherein the information storage unit comprises a fuse circuit configured to be programmed in response to the compression information.

6. The semiconductor memory device of claim 4, wherein the signal selection unit comprises:
a first select output section configured to output a source select signal as the normal select signal in response to an output signal of the information storage unit; and
a second select output section configured to output the source select signal as the redundancy select signal in response to the output signal of the information storage unit.

7. A semiconductor memory device comprising:
a memory cell array comprising a normal memory cell and a redundancy memory cell and configured to store data;
a data compression unit configured to compress data stored in memory cell groups each obtained by grouping a first number of memory cells in the memory cell array and generate compression information;
a plurality of information storage units configured to store the compression information corresponding to the respective memory cell groups and generate an output signals;
a signal select unit configured to activate a normal select signal for accessing the normal memory cell or a redundancy select signal for accessing the redundancy memory cell in response to the output signals of the information storage units; and
an address reflection unit configured to output an address as the normal select signal and the redundancy select signal and activate a final select signal.

8. The semiconductor memory device of claim 7, further comprising an enable control unit configured to generate a plurality of enable signals for activating the plurality of information storage units, respectively, in response to the address.

9. The semiconductor memory device of claim 7, wherein each of the information storage units comprises a fuse circuit configured to be programmed in response to the compression information.

10. The semiconductor memory device of claim 7, wherein the signal selection unit comprises:
a first select output section configured to output a source select signal as the normal select signal in response to the output signals of the information storage units; and
a second select output section configured to output the source select signal as the redundancy select signal in response to the output signals of the information storage units.

11. A semiconductor memory device comprising:
a plurality of memory cell arrays each comprising a normal memory cell and a redundancy memory cell and configured to store data;
a data compression unit configured to compress data stored in a plurality of memory cell arrays corresponding to an address among the memory cell arrays and generate compression information;
an address storage unit configured to store the address in response to the compression information and generate an output signal;
an address comparison unit configured to compare the output signal of the address storage unit with an address applied during a memory operation; and
a signal select control unit configured to activate a normal select signal for accessing the normal memory cell or a redundancy select signal for accessing the redundancy memory cell in response to an output signal of the address comparison unit.

12. The semiconductor memory device of claim 11, wherein the address storage unit is activated in response to the compression information, and the address storage unit comprises a plurality of fuse circuits configured to be programmed in response to a plurality of bits of the address, respectively.

13. The semiconductor memory device of claim 12, wherein the number of fuse circuits is equal to the number of bits of the address.

14. An operation method of a semiconductor memory device, comprising:
compressing data stored in a memory cell array;
performing a programming operation on a fuse in response to an output signal of a compression unit that compresses the data stored in the memory cell array; and
performing a repair operation for accessing a redundancy memory cell in response to an output signal corresponding to the fuse.

15. The operation method of claim 14, further comprising accessing a normal memory cell in response to the output signal corresponding to the fuse during a memory operation.

16. The operation method of claim 14, wherein the performing of the programming operation comprises performing the programming operation in response to the output signal of the compression unit that compresses the data stored in the memory cell array.

17. The operation method of claim 14, wherein the performing of the programming operation is activated in response to the output signal of the compression unit that compresses the data stored in the memory cell array and comprises performing the programming operation in response to a corresponding address.

18. The operation method of claim 17, further comprising comparing an address applied during a memory operation with the corresponding address.

19. The operation method of claim 18, wherein the performing of the repair operation comprises accessing the redundancy memory cell in response to an activated output signal of an address comparison unit that compares the address and the corresponding address.

20. The operation method of claim 18, further comprising accessing a normal memory cell in response to a deactivated output signal of an address comparison unit that compares the address and the corresponding address.
